(19) United States
(12) Patent Application Publication
(10) Pub. No.: US 2014/0122181 A1
(43) Pub. Date: May 1, 2014

(54) DEMAND RESPONSE LOAD FORECASTER

(71) Applicant: Honeywell International Inc., Morristown, NJ (US)

(72) Inventors: Radek Fisera, Mnichovice (CZ); Jan Berka, Prague (CZ); Jiri Rojicek, Prague (CZ)

(73) Assignee: Honeywell International Inc., Morristown, NJ (US)

(21) Appl. No.: 14/149,301

(22) Filed: Jan. 7, 2014

Related U.S. Application Data
(63) Continuation-in-part of application No. 13/621,195, filed on Sep. 15, 2012.

(51) Int. Cl. G06Q 30/02

(52) U.S. Cl. CPC G06Q 30/0202
USPC 705/7.31

(57) ABSTRACT

A demand response system having an improved load forecaster connected to a decision engine. A basis of the improved forecaster may be an introduction of an explanatory variable which is a time-based shaping function that allows capturing a demand response (DR) lead and DR rebound effect, and the like, capturing a shape of load reduction, given by an applied DR action. The engine may receive information from the forecaster and utility relative to behavior of a DR customer, market price, renewable energy generation, grid status, and so on. The engine may provide optimal timing, selection of resources, and so forth, to a DR automation server, which in turn may provide DR signals to customers. The customers may provide data consumption data to a database. Electricity generation data may also be provided to the database. Selected relevant data from the database and weather information may go to the load forecaster.

This is a continuation in part of U.S. patent application Ser. No. 13/621,195, filed Sep. 15, 2012, and entitled “Decision Support System Based on Energy Markets”. U.S. patent application Ser. No. 13/621,195, filed Sep. 15, 2012, is hereby incorporated by reference.

### BACKGROUND

The present disclosure pertains to power and particularly to stabilization of power grids. More particularly, the disclosure pertains to buying and selling power.

### SUMMARY

The disclosure reveals an improved demand response system having an improved load forecaster connected to a decision engine. A nature of the forecaster improvement is an introduction of a specific independent explanatory variable which may be a time-based shaping function that allows capturing a demand response lead and demand response rebound effect, and the like, capturing a shape of load reduction, given by an applied demand response action, regardless of the duration of a demand response event and a time of its occurrence during the day. The engine may receive information from the forecaster and a utility/independent operator system relative to behavior of a demand response customer, market price, renewable energy generation, grid status, and so on. The decision engine may provide optimal timing, selection of resources, and so forth, to a demand response automation server, which in turn may provide demand response signals to customers. The customers may provide data consumption data to a database. Electricity generation data may also be provided to the database. Selected relevant data from the database may go to the load forecaster. Weather information may also be provided to the forecaster.

### BRIEF DESCRIPTION OF THE DRAWING

FIG. 1 is a diagram of items for a power consumption forecast approach;

FIG. 2 is a diagram of revealing an example hardware context of a demand forecaster;

FIG. 3 is diagram of a graph showing an example of a participant's behavior in terms of magnitude of energy usage versus time during a demand response period;

FIG. 4 is a diagram of a graph showing another example of a participant's behavior in terms of magnitude of energy versus time during a demand response period;

FIG. 5 is a diagram of demand response and temperature data for a recorded period;

FIG. 6 is a diagram that is an enlargement of a right portion of upper portion of FIG. 5;

FIGS. 7 and 8 are diagrams that provide similar information as the diagrams of FIGS. 5 and 6, respectively, except that the Figures cover another period of time;

FIGS. 9 and 10 are diagrams that provide similar information as the diagrams of FIGS. 5 and 6, respectively, for another period of time but do not indicate DR events and DR shaping function curves; and

FIGS. 11 and 12 are diagrams that provide similar information as the diagrams of FIGS. 9 and 10 except they cover a different period of time.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

The present approach and system may have relevance, among other things, to application of or be an integral part of building automation systems and particularly to HVAC systems.

Demand response may be a popular and relatively simple approach in how to adjust current electricity demand (usually by reducing the load) of available supply. As a result, the risk of power blackouts may be substantially lowered and moreover the grid may be operated in a more economic way. The utilities (i.e., demand response program providers) may then face a challenge of how to optimally distribute the demand response signals among virtually all interested (subscribed) subjects. On one hand, the utilities may strive to achieve the desired load reduction with maximum confidence, because any additional power resource that would have to be added to satisfy the demand may be extremely costly. In other words, at this time, utility companies may often rather exceed really required total load reduction to make sure that the demand reduction is met. And, on the other hand, unnecessary exaggerated load reduction may not be economically optimal, because the utility then might do such things as pay more incentives to the subscribers.

Thus, there appears to be a strong need for an accurate demand forecaster or predictor. The forecaster may have to provide not only the prediction of the baseline demand but importantly also the prediction of load behavior during the demand response. It should be noted that a DR event may also affect the time before the DR event, called a “DR lead”, and time right after DR event, called a “DR rebound”. A reason may be that addressed facilities try to prepare themselves for an upcoming event (i.e., through the pre-cooling) and after the DR event, the facilities need to recover from, for instance, a temporarily compromised comfort or simple executed postponed energy demanding actions. Data available to the utility may be just that gathered by telemetry (i.e., with an advanced metering infrastructure) system from remote smart electricity meters installed at subscribers' facilities. The utility should have knowledge in advance how the DR program participant will likely behave if it receives the load shed request (DR event signal). The situation may be further complicated by the fact that the demand response event can occur at different times during the day and the effect of demand response actions, performed by the facility operator, may also be strongly dependent on the actual driving conditions. Some load modeling/forecasting techniques (data-centric/empirical) may typically fail when trying to cope with the last two mentioned challenges, especially a varying DR event occurrence during the day that may result in unreliable demand forecasts. Other modeling techniques (like models based on first principles) may be unnecessarily complex and therefore expensive for this task.

The present approach may solve the noted issues by enhancing the data-centric/empirical approach with defined explanatory variables. A primary feature may introduce a demand response time-based shaping function that allows capturing a DR lead and DR rebound effect, and capturing a shape of load reduction (given by an applied DR response action) regardless of the duration of a DR response event and a time of its occurrence during the day.

The present approach may algorithmically combine (e.g., using a weighted sum) the first and second results respectively of two predictors. There may be additional predictors. The first results may be specialized on a DR event and the second results may be specialized on an out-of-DR event. The weights may be computed according to a preceding accuracy of both predictors (forecasters) for a given set of driving conditions (e.g., Bayesian model averaging), or simply according to a relative distance of a currently estimated point from the middle of a DR event (which may be useful as an initial setup for the new customers with no, or just a very short history such as a day or so available).

An effect of newly defined explanatory variables may be verified using, for example, a local kernel polynomial regression method. It may be applicable to a larger class of data-centric approaches that uses the independent explanatory variables concept together with a data search (localness) for demand modeling.

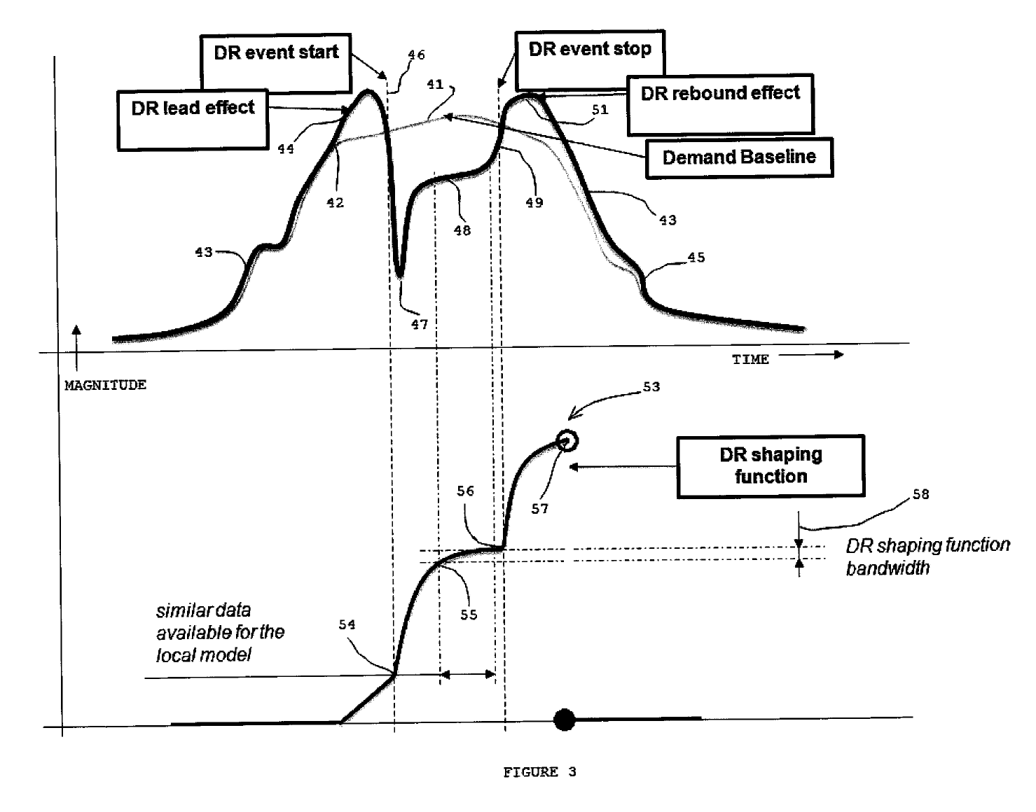

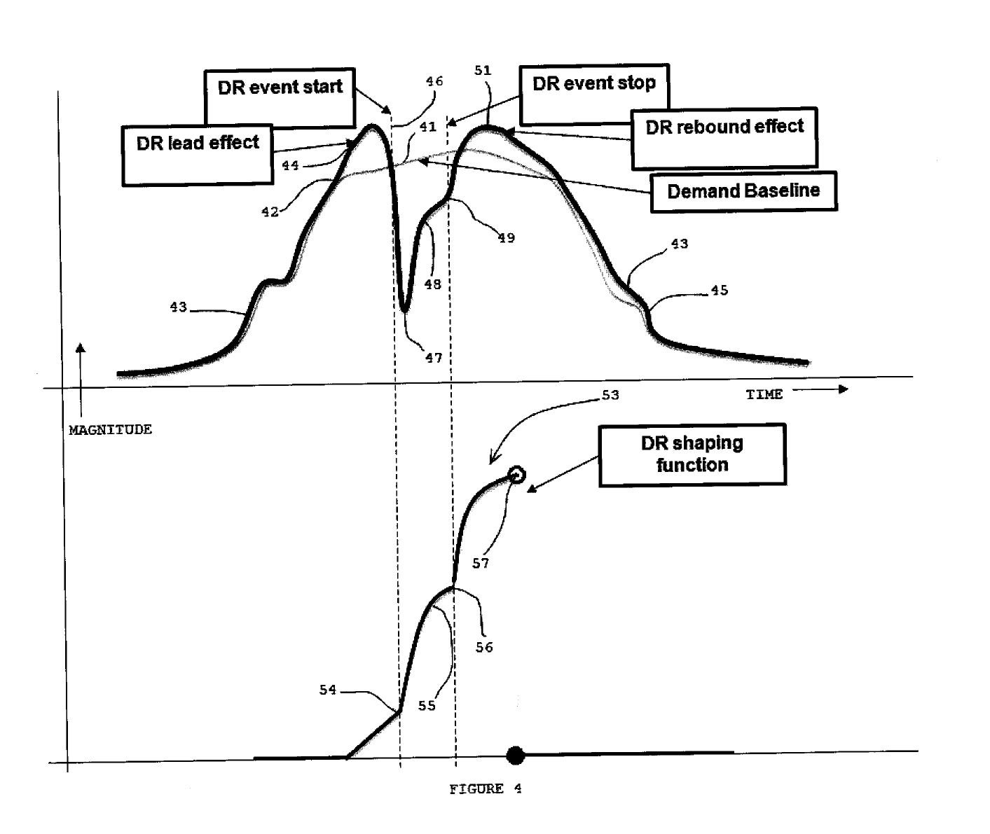

A regression may be used for testing the built prediction models on-the-fly for each queried point locally. The present approach (as many others) may search for data similar to the actual operating point, assuming that the modeled system behaves similarly under like conditions. A definition of “similarly” may be crucial, since no approach considered so far appeared to be focused on specific DR event properties. The present DR shaping function may basically represent relative time within the DR event including a DR lead and DR rebound. Furthermore, the relative time might not necessarily be running linearly, i.e., it can run faster when there is a need to capture more details, and similarly, it can run slower when not many details are expected in the demand. Illustrative diagrams may be noted in FIGS. 3 and 4.

Based on the exploration of electricity demand data from large number of facilities that participated in the demand response, one may provide a shape of the explanatory variable capturing the relative time within DR event (including the rebound and lead effect). The shape may reflect how a typical (statistically evaluated) participant behaves immediately before, during and right after the DR event. The approach may be tested against an electricity demand collected during numerous DR events from a number of various participants (various load types and DR strategies).

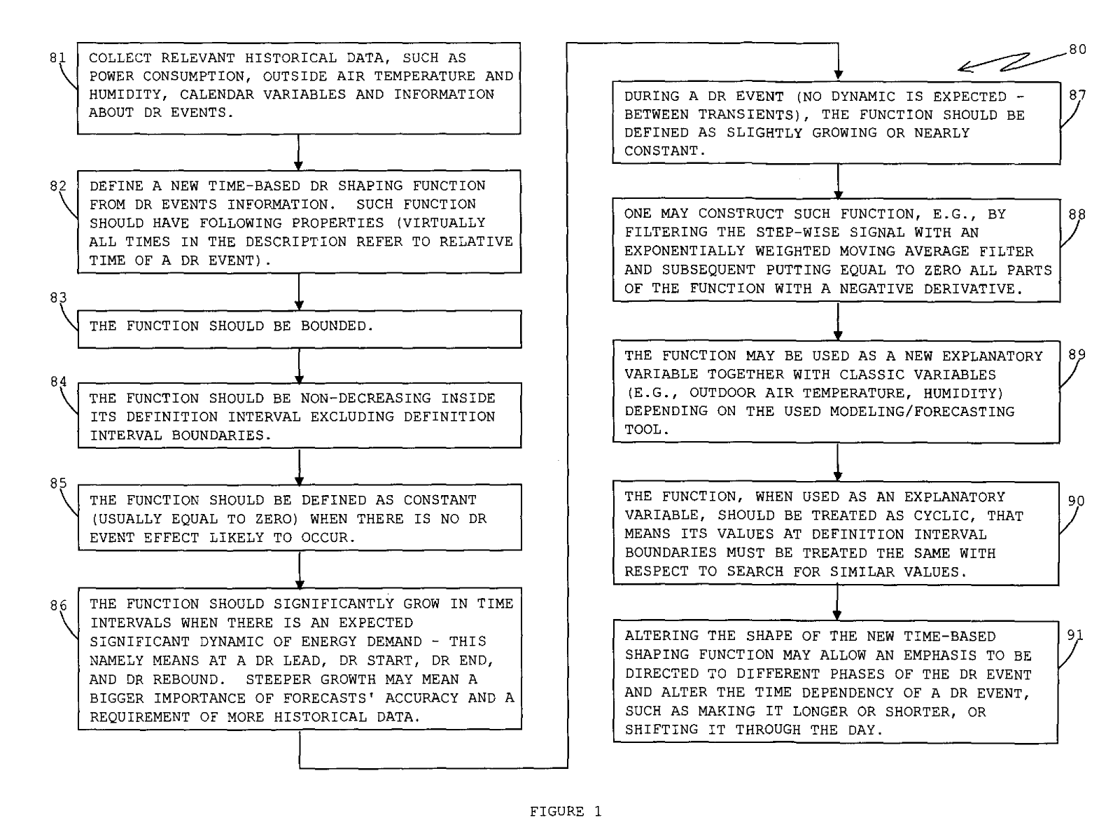

To get a power consumption forecast using the present approach, FIG. 1 is a diagram 80 showing items 81 through 91 that may be noted and/or performed, respectively, in an order of the following. 1) Collect relevant historical data, such as power consumption, outside air temperature and humidity, calendar variables and information about DR events. 2) Define a new time-based DR shaping function from DR events information. Such function should have following properties (virtually all times in the description herein refer to relative time of a DR event). 3) The function should be bounded. 4) The function should be non-decreasing inside its definition interval excluding definition interval boundaries. 5) The function should be defined as constant (usually equal to zero) when there is no DR event effect likely to occur. 6) It should significantly grow in time intervals when there is an expected significant dynamic of energy demand—this namely means at a DR lead, DR start, DR end, and DR rebound. Steeper growth may mean a bigger importance of forecasts' accuracy and a requirement of more historical data. 7) During a DR event (no dynamic is expected—between transients), the function should be defined as slightly growing or nearly constant. 8) One may construct such function, e.g., by filtering the step-wise signal with an exponentially weighted moving average filter and subsequent putting equal to zero all parts of the function with a negative derivative. 9) The above function may be used as a new explanatory variable together with classic variables (e.g., outdoor air temperature, humidity) depending on the used modeling/forecasting tool. 10) The above function, when used as an explanatory variable, should be treated as cyclic, that means its values at definition interval boundaries must be treated the same with respect to search for similar values 11) Altering the shape of the new time-based shaping function may allow an emphasis to be directed to different phases of the DR event and alter the time dependency of a DR event, such as making it longer or shorter, or shifting it through the day.

A motivation may incorporate the following items. Accurate predictions of the system behavior (load) in a DR environment may be required to support a decision engine (typically in a UIS—utility information system). The decision engine may solve a task of optimum timing and selection of DR resources (via a what-if analysis).

A task statement may deliver a baseline and a DR affected electricity demand forecast. Various prediction horizons (day-ahead, several hours ahead or shorter—fast DR) may be considered. A large number of forecasts may be requested in a short time interval. One may assume that only data from resource electricity meters are available (e.g., 15 min sampling).

A set of applicable forecasting approaches may be narrowed to data driven statistical/empirical one. It may be noted that this is slowly changing as the number of customers that need the forecaster—ESCOs (energy service companies), aggregators, and so forth, having an access to site internal data (supported also by OpenADR2.0—open automated demand response) may be increasing; it may however be a different task statement. Aggregators may bring together collections of aggregated DR assets and sell them to the grid as a single resource.

The approach, in a brief manner, may combine smart results from several specialized forecasters. There may be an underlying technique for verification tests such as robust local polynomial regression (e.g., lazy learning approach) with particularly defined regressors (based on explanatory variables). The approach may use a similar data search when identifying a local model for a specific query point. The approach may be applicable for exploiting a similar data search.

The approach may also note the available inputs. There may be a set of available explanatory variables for electricity demand modeling/forecasting. The variables may incorporate calendar variables (i.e., time of day, day type such as a working day, holiday, and so on).

The variables may incorporate demand response signals, such as a DR event start and stop time, and DR event mode. They may incorporate weather data such as outdoor air temperature, humidity, solar radiation, and so forth. Both past data and forecasts may be obtained from publicly available sources.

The time-based DR shaping function may be introduced as a new explanatory variable to possibly any data-centric forecaster. Data-centric (or data-based) forecasting algorithms may virtually always be based on directly observed explanatory variables like time-of-day, day-of-week, outdoor temperature, and so on. As a DR event may have its dynamic, it appears quite useful to introduce a new explanatory variable, a “DR shaping function”. A goal of the DR shaping function is to “warp” time near to important situations in a DR event such as a DR lead, DR rebound, and so forth, which can make the data-centric forecaster more sensitive near those situations. That is, the forecaster may need data really similar to the current point of interest near those situations, which can make the forecaster more accurate but needing more historical data. On contrary, in other less important situations when usually less historical data is available, the DR shaping function may make the forecaster more benevolent (i.e., it can work with less similar data).

A description of data-centric forecaster may emphasize working on data and not necessarily be based on physical principles of the system. Introduction of the new explanatory variable may help increase the accuracy of forecasting. The DR shaping function may be used for virtually any data-centric forecaster. The local kernel polynomial regression noted herein may be just an example. The present approach is not necessarily about a demand response load forecaster, but may be more about improving the demand response load forecaster by introducing a time-based DR shaping function, or the like.

FIGS. 3 and 4 are graphs of data that illustrate a participant's example behavior during a DR period. Implications of such behavior may be noted. Important changes in the electricity demand may happen typically immediately after the DR event start and stop. The DR shaping function may have a steep slope (i.e., relative time is running faster than linear). A similar search may then be allowed to pick up less data for the same DR shaping function bandwidth. After the transient caused by turning ON/OFF devices vanishes, the demand may become more or less steady-fixed. The DR shaping function may be changing slowly (i.e., slope is getting close to zero). A similar search may then be allowed to pick up more data for the same DR shaping function bandwidth.

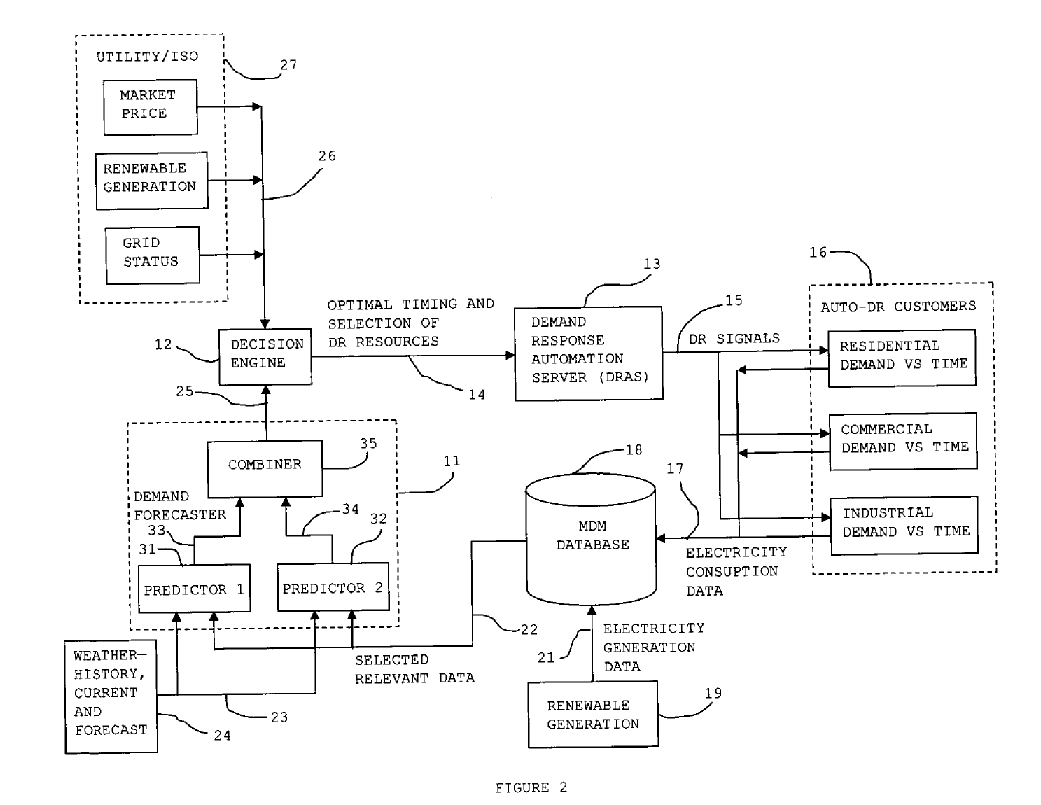

FIG. 2 is a diagram revealing an example of a hardware context for a demand forecaster 11. An output 25 of forecaster 11 may go to a decision engine 12. An output 14 from may go to a demand response automation server (DRAS) 13. The decision engine output 14 may incorporate optimal timing and selection of DR resources. DR signals 15 may be provided by server 13 to auto-DR customers 16. Examples of customers 16 may incorporate residential, commercial and industrial ones. An output 17 from customers 16 may incorporate electricity consumption data. Output 17 may also incorporate demand versus time information about each of the customers 16.

Output 17 may go to a database 18. Database 18 may incorporate meter data management (MDM). A renewable generation module 19 may provide an output 21 of electricity generation data to database 18. Database 18 may provide an output 22 to forecaster 11. Output 22 may be relevant data selected by forecaster 11 and/or database 18. Also, weather information incorporating current conditions, a history of conditions, and forecasts may be provided as an output 23 from a weather module 24 to forecaster 11. Information pertaining to market price, renewable generation and grid status may be provided as an output 26 from a utility/ISO 27 to decision engine 12.

Forecaster 11 may have a predictor 31 and a predictor 32. Predictor 31 may have results specialized on a DR event and Predictor 32 may have results specialized on an out-of-DR event. Results of an output 33 from predictor 31 may go to a combiner 35. Results of an output 34 from predictor 32 may go to combiner 35. Output 22 from database 18 and output 23 from weather module 24 may go to predictors 33 and 34. An output 25 from combiner 35 may go to decision engine 12.

FIG. 3 is diagram of a graph showing an example of a participant's behavior in terms of magnitude of energy usage versus time during a demand response period. The main basis of FIG. 3 may be in that a line 41 shows a typical customer behavior without a DR event and the line 43 shows a typical customer behavior with DR event in place.

A demand baseline 41 may follow closely the participant's behavior, when there is no DR event in place. The 43 may show participant's behavior, when there is DR event deployed. Curve 43 may start to drop shortly before a start of a DR event at time 46. After a significant drop to a dip at point 47, curve 43 may rise abruptly at point 47, and then a rise begins to level out at point 48. Just before a stop of the DR event at point 49, curve 43 rises up to a rounded peak at point 51 which may be regarded as a rebound effect.

A lower portion of the graph in FIG. 3 reveals a DR shaping function curve 53. The DR event start appears at point 54 with an intersection of time line 46. A significant change in slope is revealed by curve 53 between point 54 and point 55. The leveling out of the slope of curve 43 at point 48 may be represented by the leveling out of curve 53 between point 55 and point 56. The DR event stop is indicated at point 56. The rebound effect at point 51 is indicated by a steep rise of curve 53 between point 56 and point 57. A distance of the rise of curve 53 between point 55 and point 56 may be an indication of a DR shaping function bandwidth 58.

FIG. 4 is a diagram of a graph showing another example of a participant's behavior in terms of magnitude of energy versus time during a demand response period. The rise abruptly at point 47 of curve 43, after a period of time, may begin to level out at point 48 but only for a much more brief time when compared to curve 43 at point 48 in FIG. 3. This difference may be revealed in the DR shaping function of curve 53 being much steeper and briefer at point 55 between points 54 and 56 in the lower portion of the graph in FIG. 4.

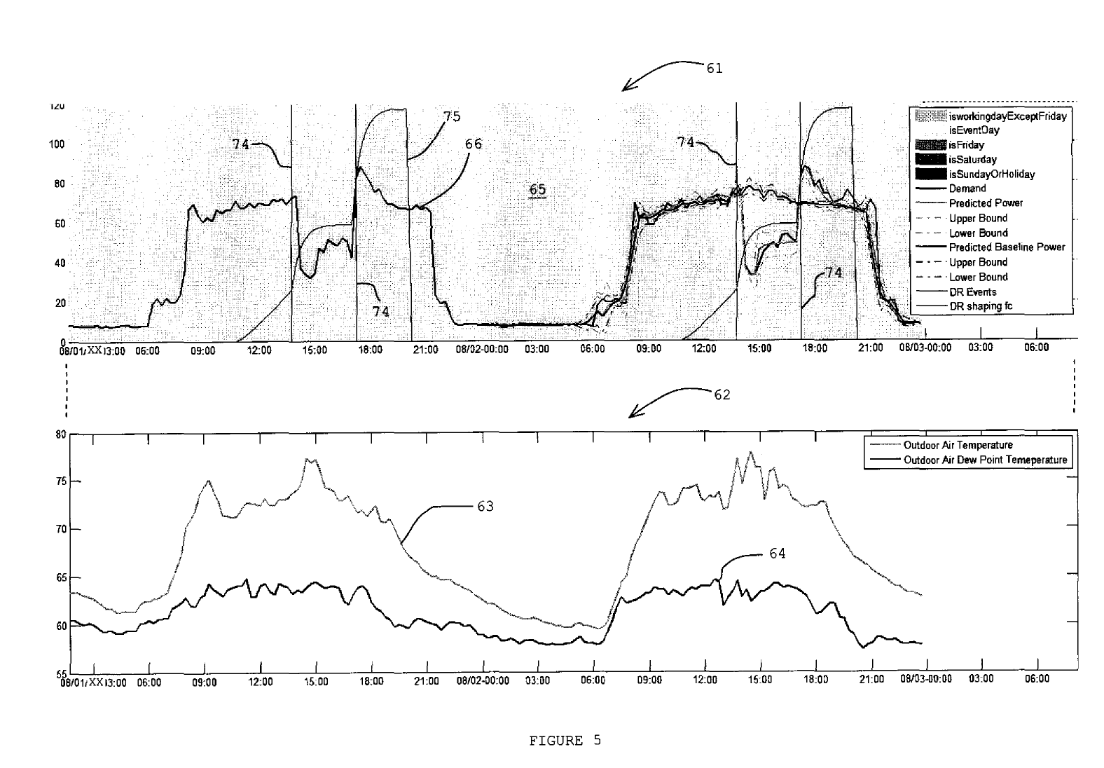

FIGS. 5 through 12 are diagrams of graphs relating to a day-ahead prediction of demand response. The upper portion 61 of the graphs may relate to demand response activity versus time of the day. The lower portion 62 of the graphs indicate the outdoor temperature 63 and outdoor air dew point temperature 64 corresponding to the same time of the day as the upper portion 61 of the graphs. The graphs reveal demand response information for dissimilar temperature patterns, various days, and different times.

FIG. 5 is a diagram of demand response and temperature data for a period from Aug. 1, 20XX, into Aug. 3, 20XX. Portion 61 reveals the demand response activity involving demand 66 and DR shaping function 75. Portion 62 reveals the outdoor air temperature 63 and the outdoor dew point temperature 64 for the same period of time.

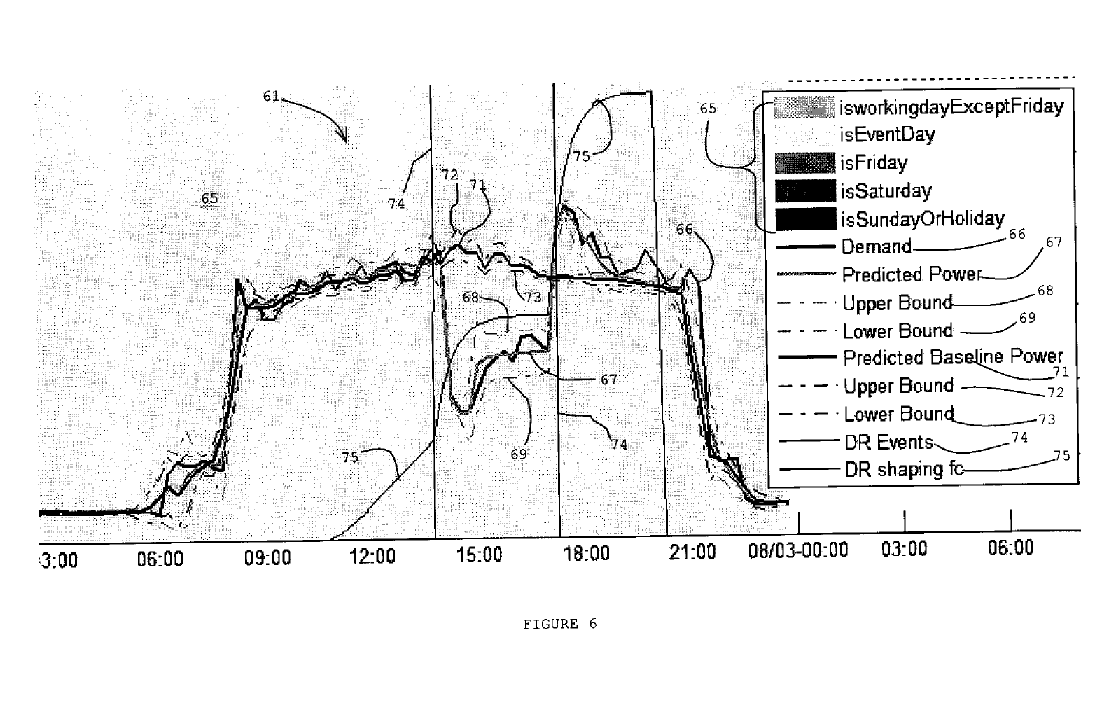

FIG. 6 is a diagram that is an enlargement of a right portion of portion 61. Background 65 may indicate by shading whether the day is a working day except Friday, an event day, Friday, Saturday, Sunday or a holiday. In the present case, background 65 shading appears to match that for an event day.

Demand may be as indicated by a curve 66. Predicted power may be indicated by curve 67. The upper and lower bounds of the predicted power may be indicated by curves 68 and 69, respectively. Predicted baseline power may be indicated by curve 71. The upper and lower bounds are indicated curves 72 and 73, respectively. DR event start and stop times may be indicated by lines 74. A DR shaping function may be indicated by a curve 75.

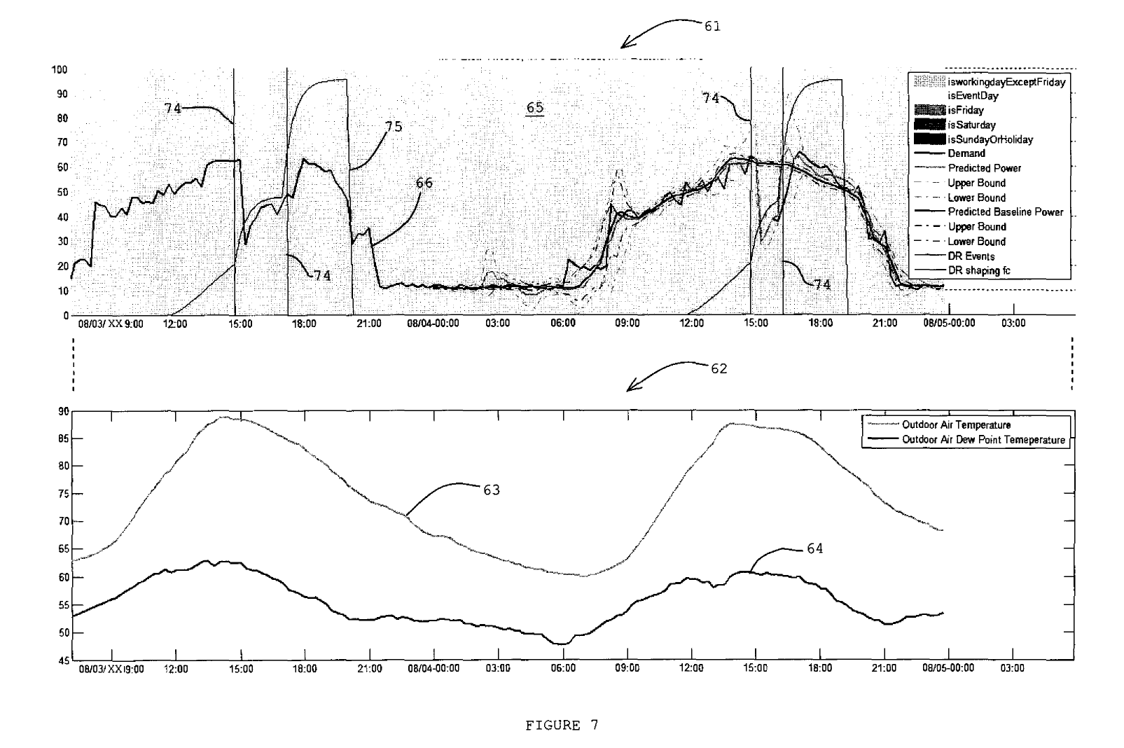

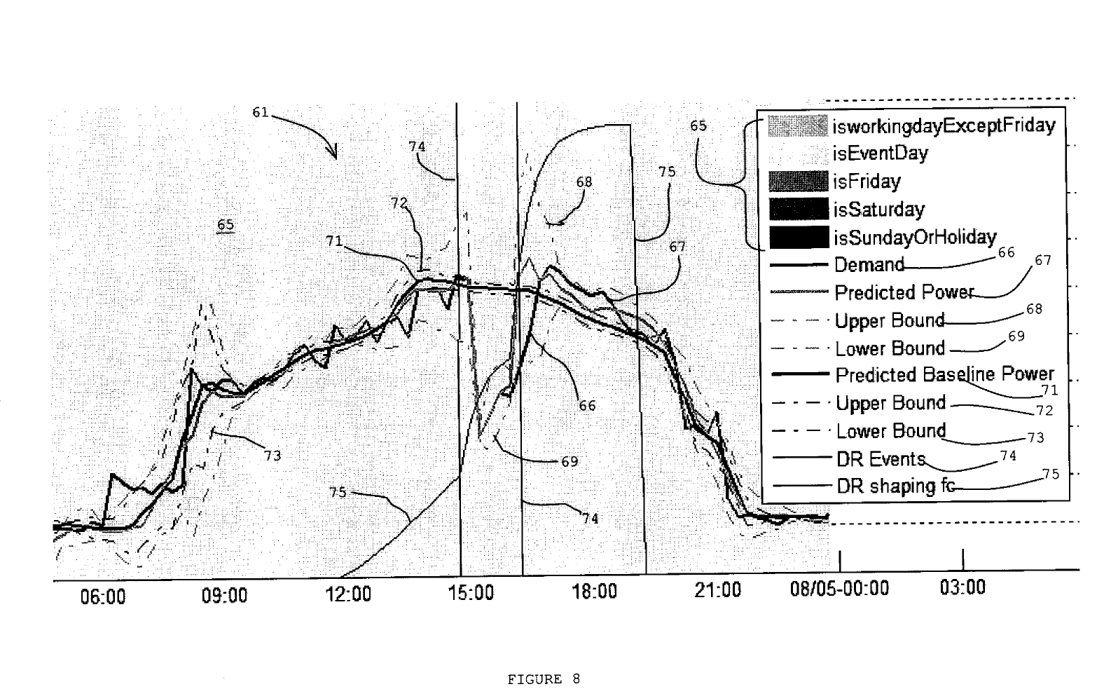

FIGS. 7 and 8 are diagrams that provide similar information as the diagrams of FIGS. 5 and 6, respectively, except that FIG. 7 covers a period of time of Aug. 3, 20XX, up into August 5.

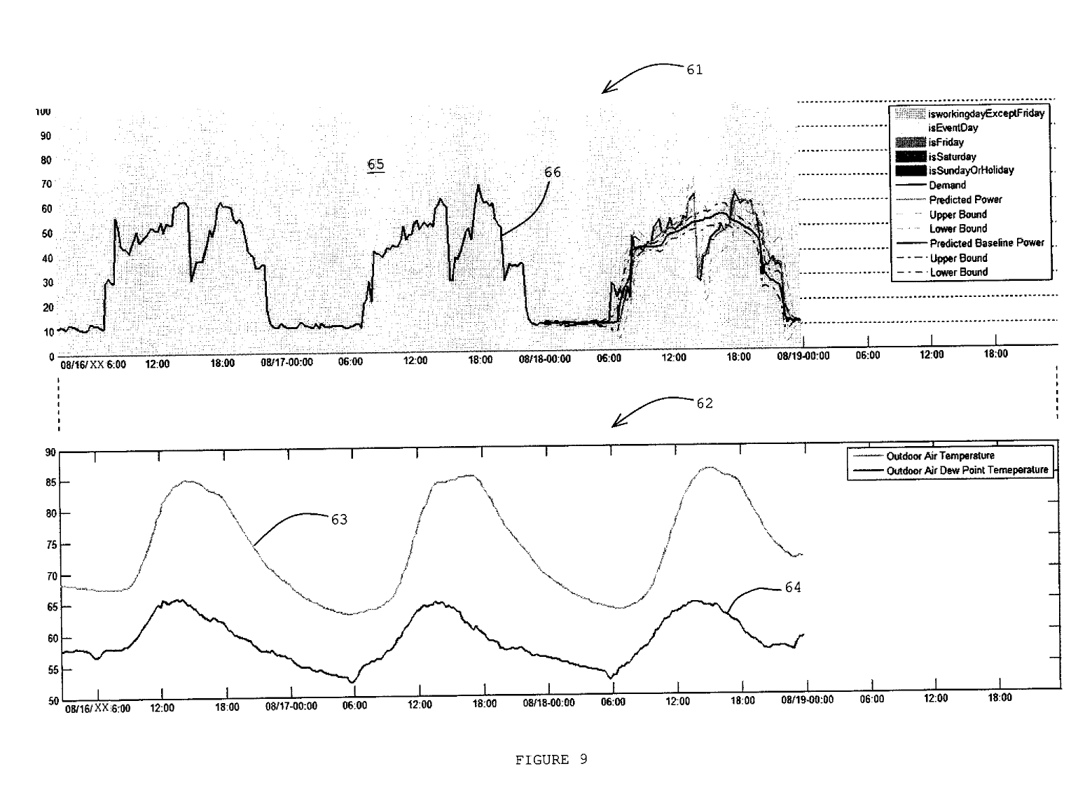

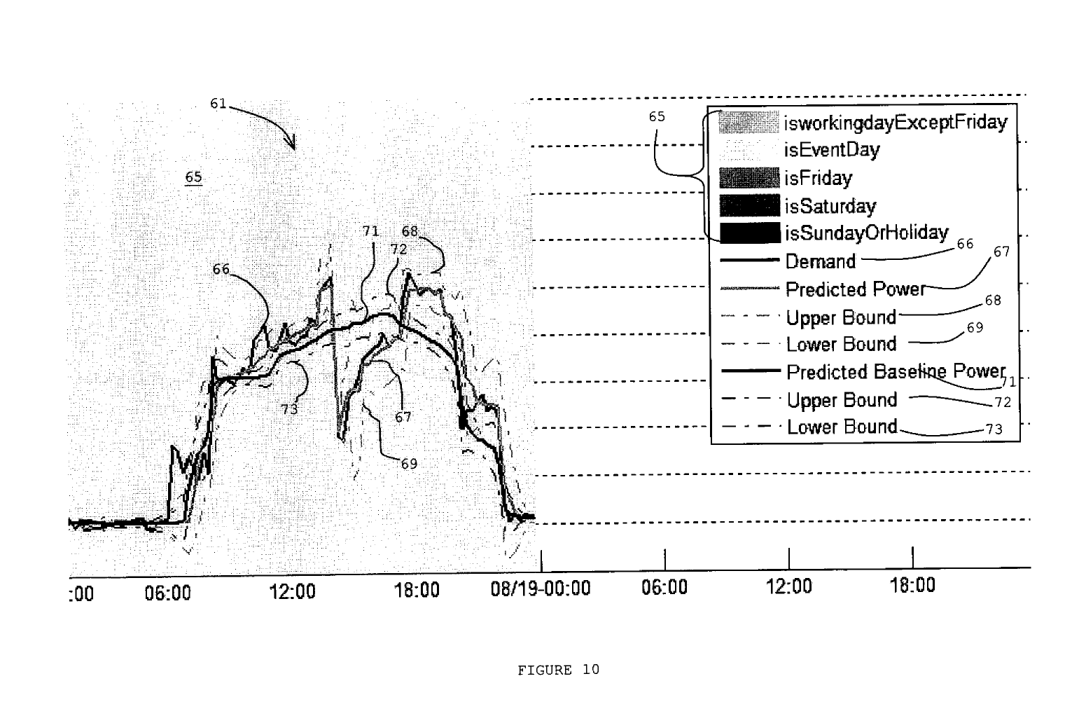

FIGS. 9 and 10 are diagrams that provide similar information as the diagrams of FIGS. 5 and 6, respectively, except that the diagrams of FIGS. 9 and 10 do not indicate the DR events and the DR shaping function curves 74 and 75, respectively. Also, FIG. 9 covers a period of time during Aug. 18, 20XX, into August 19.

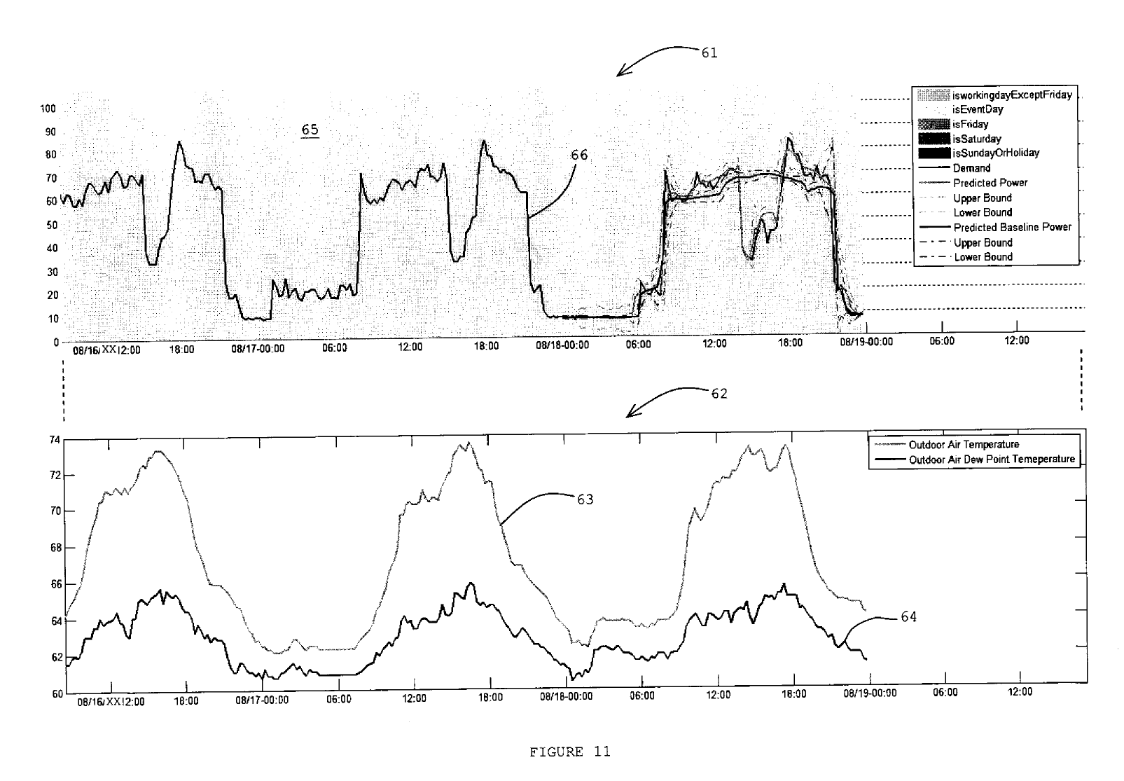

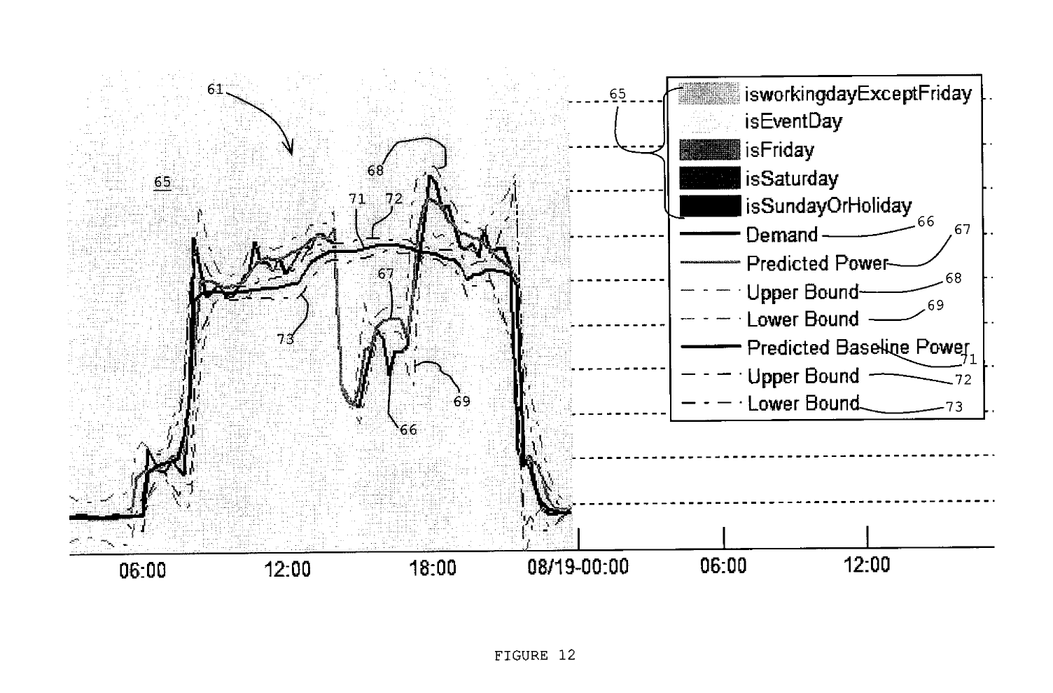

FIGS. 11 and 12 are diagrams that provide similar information as the diagrams of FIGS. 9 and 10 except that FIG. 11 covers a period of time of Aug. 16, 20XX up to August 19.

To recap, an approach of demand response (DR) load forecasting may incorporate providing a computer, collecting and entering into the computer historical data pertaining to power consumption, outside temperature, humidity, calendar variables and/or information about DR events, defining a non-decreasing cyclic time-based shaping function from information about DR events, bounding the time-based shaping function, and altering an output of the time-based shaping function relative to different phases of a demand response event. The defining the time-based shaping function, the bounding the time-based shaping function, and the altering of the time-based shaping function may be performed, at least in part, by the computer.

The time-based shaping function may permit capturing a DR lead, a DR rebound effect, and a shape of load reduction. The shape of load reduction may be given by an applied DR action. A shaping function may represent relative time within a DR event incorporating a DR lead and a DR rebound.

Relative time may be non-linear with respect to real time. Relative time may move faster when more details to capture occur. Relative time may move slower when fewer details to capture occur.

Energy demand data from one or more facilities participating in a demand response program may determine a shape of a variable capturing a relative time within a DR event incorporating rebound and lead effects. The shape may indicate how a statistical typical facility, determined to be statistically average of the two or more facilities, behaves immediately before the DR event, during the DR event, and immediately after the DR event.

A system, for supporting a demand response (DR) decision engine, may incorporate a computer having a decision engine, and a forecaster connected to the decision engine.

The decision engine may provide an optimum timing and selection of DR resources based on a result from the forecaster. Variables may be provided to the forecasters. The variables may incorporate information based on time, DR signals and/or weather. A DR shaping function may be developed from the variables based on DR signals.

Variables based on time may incorporate time of day, day and/or type of day. Variables based on DR signals may incorporate a DR event start time, DR event stop time, DR event mode, DR lead effect, DR rebound effect and/or demand baseline.

Variables based on weather may incorporate outdoor air temperature, humidity, solar radiation, wind, past data, current data and/or forecast data.

Changes in electricity demand may occur almost immediately after the DR event start time and DR event stop time.

The electricity demand may become more or less steady fixed after a transient, caused by devices turning on and off on consumed electricity, vanishes. The electricity demand, becoming more or less steady fixed, may result in the DR shaping function having a slope approaching zero.

A result from the forecaster may be obtained by one or more defined regressors that provide a regression based on the variables.

A mechanism for demand response (DR) load forecasting, may incorporate a computer having a DR automation server, a decision engine connected to the DR automation server, and a demand forecaster connected to the decision engine.

The demand forecaster may incorporate a module for providing a DR time-based shaping function that captures a DR lead, a DR rebound effect, and a shape of a load reduction given by an applied DR action despite a duration of a DR event and a time of an occurrence of the DR event during a day of the DR event.

The mechanism may further incorporate an energy consumption database connected to the demand forecaster.

The mechanism may further incorporate a weather information module connected to the demand forecaster. The DR automation server may have an output for DR signals to one or more customers. The energy consumption database may have an input for electricity consumption data from one or more customers.

The demand forecaster may incorporate a combiner connected to the decision engine, a first predictor connected to the combiner, and a second predictor connected to the combiner. The energy consumption database may be connected to the first and second predictors. The weather information module may be connected to the first and second predictors.

The outputs of the first and second predictors may be combined according to weights of the first and second predictors, respectively. The weights may be computed according to preceding accuracies of the first and second predictors.

An output of the demand forecaster may have a measure incorporating a distance of a currently estimated point from the middle of a DR event.

The electricity consumption data may be collected concerning demand during one or more DR events from one or more customers having received DR signals from the automation server. The energy consumption data to the demand forecaster may contribute to predicting behavior of a customer in response to one or more DR signals.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A method of demand response (DR) load forecasting comprising:
providing a computer;
collecting and entering into the computer historical data pertaining to power consumption, outside temperature, humidity, calendar variables and/or information about DR events;
defining a non decreasing cyclic time-based shaping function from information about DR events;
bounding the time-based shaping function; and
altering an output of the time-based shaping function relative to different phases of a demand response event; and
wherein the defining the time-based shaping function, the bounding the time-based shaping function, and the altering of the time-based shaping function are performed, at least in part, by the computer.

2. The method of claim 1, wherein:
the time-based shaping function permits capturing a DR lead, a DR rebound effect, and a shape of load reduction; and
the shape of load reduction is given by an applied DR action.

3. The method of claim 2, wherein a shaping function represents relative time within a DR event incorporating a DR lead and a DR rebound.

4. The method of claim 3, wherein:
relative time can be non-linear with respect to real time;
relative time moves faster when more details to capture occur; and
relative time moves slower when fewer details to capture occur.

5. The method of claim 3, wherein energy demand data from one or more facilities participating in a demand response program determine a shape of a variable capturing a relative time within a DR event incorporating rebound and lead effects.

6. The method of claim 5, wherein the shape indicates how a statistical typical facility, determined to be statistically average of the two or more facilities, behaves immediately before the DR event, during the DR event, and immediately after the DR event.

7. A system for supporting a demand response (DR) decision engine, comprising:
a computer comprising a decision engine; and
a forecaster connected to the decision engine; and
wherein:
the decision engine provides an optimum timing and selection of DR resources based on a result from the forecaster;
variables are provided to the forecasters;
the variables comprise information based on time, DR signals and/or weather; and
a DR shaping function is developed from the variables based on DR signals.

8. The system of claim 7, wherein:
variables based on time comprise time of day, day and/or type of day; and
variables based on DR signals comprise a DR event start time, DR event stop time, DR event mode, DR lead effect, DR rebound effect and/or demand baseline.

9. The system of claim 8, wherein variables based on weather comprise outdoor air temperature, humidity, solar radiation, wind, past data, current data and/or forecast data.

10. The system of claim 8, wherein changes in electricity demand occur almost immediately after the DR event start time and DR event stop time.

11. The system of claim 7, wherein the electricity demand becomes more or less steady fixed after a transient, caused by devices turning on and off on consumed electricity, vanishes.

12. The system of claim 11, wherein the electricity demand, becoming more or less steady fixed, results in the DR shaping function having a slope approaching zero.

13. The system of claim 9, wherein a result from the forecaster is obtained by one or more defined regressors that provide a regression based on the variables.

14. A mechanism for demand response (DR) load forecasting, comprising:
a computer comprising a DR automation server;
a decision engine connected to the DR automation server; and
a demand forecaster connected to the decision engine; and
wherein the demand forecaster comprises a module for providing a DR time-based shaping function that captures a DR lead, a DR rebound effect, and a shape of a load reduction given by an applied DR action despite a duration of a DR event and a time of an occurrence of the DR event during a day of the DR event.

15. The mechanism of claim 14, further comprising an energy consumption database connected to the demand forecaster.

16. The mechanism of claim 15, further comprising:
a weather information module connected to the demand forecaster; and
wherein:
the DR automation server has an output for DR signals to one or more customers; and
the energy consumption database has an input for electricity consumption data from one or more customers.

17. The mechanism of claim 16, wherein the demand forecaster comprises:
a combiner connected to the decision engine;
a first predictor connected to the combiner; and
a second predictor connected to the combiner; and
wherein:
the energy consumption database is connected to the first and second predictors; and
the weather information module is connected to the first and second predictors.

18. The mechanism of claim 17, wherein:
the outputs of the first and second predictors are combined according to weights of the first and second predictors, respectively; and
the weights are computed according to preceding accuracies of the first and second predictors.

19. The mechanism of claim 14, wherein an output of the demand forecaster comprises a measure incorporating a distance of a currently estimated point from the middle of a DR event.

20. The mechanism of claim 16, wherein:
the electricity consumption data is collected concerning demand during one or more DR events from one or more customers having received DR signals from the automation server; and
the energy consumption data to the demand forecaster contribute to predicting behavior of a customer in response to one or more DR signals.
